(19) United States
(12) Patent Application Publication
(10) Pub. No.: US 2021/0237864 A1
(43) Pub. Date: Aug. 5, 2021

(54) Hydrofoiled aircraft

(71) Applicant: Bereli M. Lazar, San Francisco, CA (US)

(72) Inventor: Bereli M. Lazar, San Francisco, CA (US)

(21) Appl. No.: 16/873,103

(22) Filed: Feb. 3, 2020

(51) Int. Cl. B64C 35/00; B63B 1/24; B63B 1/26; B63B 1/28

(52) U.S. Cl. CPC B64C 35/006; B64C 35/007; B63B 1/28; B63B 1/26; B63B 1/248

(57) ABSTRACT

The structure includes a set of Hydrolift units and axillary devices all built in fuselage. Every Hydrolift unit has its closed loop tunnel with hydrofoils and filled by water; said tunnels work as selfboosters. This proposal suggests to use small hydrofoils which in water flow provide big lift forces independently from planes velocity. The Aircraft is free from traditional airwings and their regular (big) difficulties. The Hydrolift units can be used for any cars, trucks, buses, ships preferably combining them with Hydrodynamic closed loop turboset-selfboosters, as their powerful and fuel-exhaust-free thrust-motors.

### RELATED APPLICATIONS

a) U.S. Pat. No.: 7,296,529B2

Fluidynamic Lift Array, Technology;

b) US Patent Application No.: 20070041830

Hydrodynamic closed loop turboset selfbooster.

### FEDERALLY SPONSORED RESEARCH

None.

### SEQUENCE LISTING OR PROGRAM

None

### BACKGROUND, TECHNICAL FIELD

All aircrafts need sufficient lift forces, especially big for safe and slow take offs and landings, in turbulent air situations, and sudden maneuvers

This proposal suggests:

a) To use small built-in hydrofoils instead of traditional large air wings.

b) To use big lift forces of water flow instead of lift forces of air flow: the liquid density is in ˜1000 times higher.

c) To use closed-loop tunnels working as self boosters.

### BRIEF SUMMARY.

The object of this proposal is to suggest an aircraft with big lift forces which are not depending of plane's velocity.

It is well known that large air wings often bring difficulties connected with strong vibrations which shake up many systems and connections in airplanes; especially when the take offs, landings, and air-turbulences periodically (but constantly) occur.

Built-in hydrolift units with their kits of hydrofoils provide the task to have an aircraft with high lift possibilities and without said difficulties from big air wings' vibrations.

the Hydrofoiled Aircraft suggests much bigger lift forces and higher reliability for many planes' situations.

Any prior arts where built-in hydrolift units with their hydrofoils provide high lift forces to the aircraft, and suggested by other authors,—were not found.

### DRAWING FIGURES

In the drawings closely related elements have the same numbers but different alphabetic suffixes. Numbers of views and sections are according to numbers of figures where they are shown.

FIG. 1. Shows a side view of the Hydrofoiled Aircraft in its flight.

FIG. 2. Shows a plan view 2 from FIG. 1.

FIG. 3. is a cross section 3-3 taken from FIG. 1.

FIG. 4. is a plan view of hydrolift unit.

FIG. 5. is a cross section 5-5 taken of FIG. 4.

FIG. 6. is a cross section 6-6 taken of FIG. 5.

FIG. 7. is a scheme of an exemplary hydrofoil in tunnel water flow. The wire connections are not shown as obvious and well known.

### REFERENCE NUMBERS AND SYMBOLS IN DRAWINGS

20—Fuselage

21—Thrust motor

22—Horizontal stabilizer

23—Vertical stabilizer

24—Auxiliary Winglet

25—Elevator

26—Aileron-flaps

27A, B—Rudders

28A, B—Landing Shassis

30—Hydrolift unit

31—Closed-loop tunnel; 31w—water

32C—Hydrofoil control

33—Kit of guide-grids

33C—Guide-grid control

34—Bypass, 35—Piston valve, 36—Meters

37—Plate, 38—Heat shield

39—Pump station, 40—Axial flow pump

41—Pump motor, 42—Pump drive

W_{f}—Water flow inside tunnel 31

P_{ab}—Pressure above the hydrofoils 32A, B

Pᵤₙ—Pressure under the hydrofoils 32A, B

L—Hydrofoil lift force

α—Hydrofoil angle clearly of attack.

### DETAILED DESCRIPTION

The Hydrofoiled Aircraft includes a set of Hydrolift units 30 and regular devices, all built in fuselage 20. Every Hydrolift unit 30 has its closed loop tunnel 31 with Hydrofoils 32A, B and filled by water 31w; the pump station 39, control devices, 32C, 33, 33C, meters provide needed conditions to the interactions.

The auxiliary winglets 23, all the stabilizers, elevators, rudders help to provide effective control and maneuvers in flights. The basic formulae for hydrodynamic lift are well known.

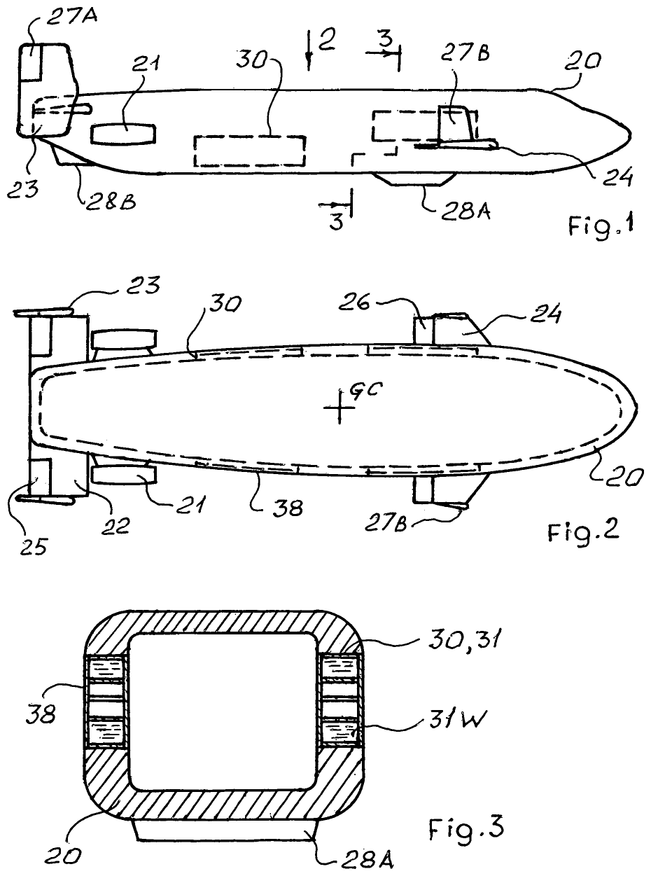

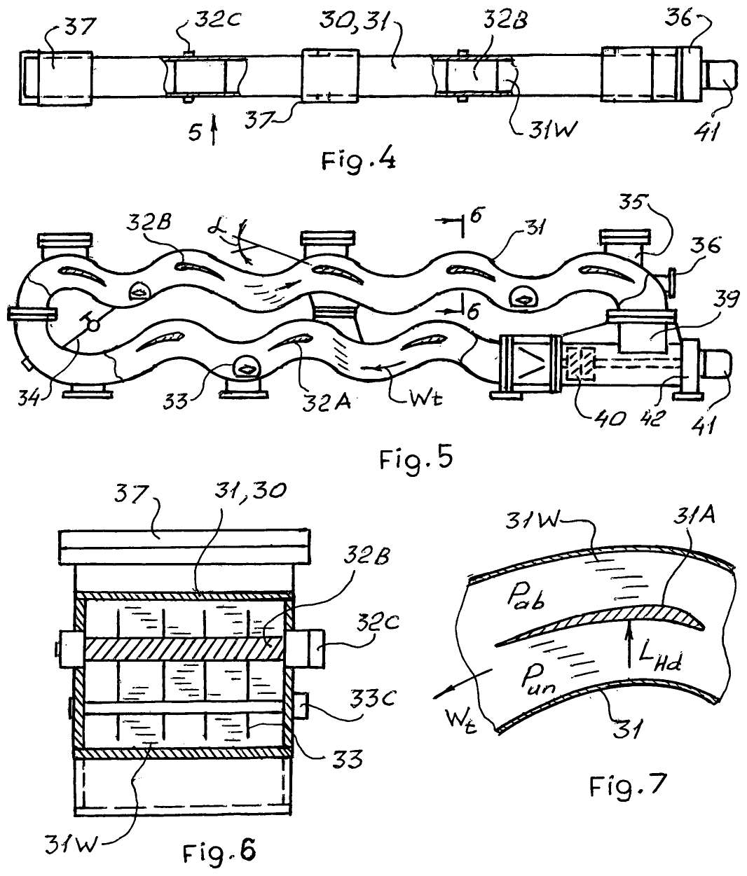

The specifics of all devices and their functions are clearly shown on the drawings, FIGS. 1 to 7. The thrust motors 21 of the plane can be different: turbofans, turbojets, turboprops, propeller and hybrid propulsion systems.

### Operation and Interactions

The axial flow pump 40 works as selfbooster impelling the water 31w in closed loop tunnel 31 for hydrofoils 32A, B, and for itself, and at itself. This is an accumulative method when a singular pump performs actually in series with itself providing high potential circulative hydrodynamic flow inside tunnel 31 multiplying pressure ratio of the water flow w_{f} and suppressing any possible cavitation.

The operative water flow w_{f} provides to Hydrofoils 32A, B Hydrodynamic lift-forces L, which all together form the common lift for the Hydrofoiled Aircraft which is transmitted to the fuselage 20 by plates 37.

1. A Hydrofoiled Aircraft comprises a method and means based on combined usage of closed-loop waved tunnel-units filled with water and having sets of controlled hydrofoils.

2. The Hydrofoiled Aircraft of claim 1, wherein said tunnel-units equipped with pump-stations working in self-series as self-boosters.

3. The Hydrofoiled Aircraft of claim 1, wherein said tunnel-units are built-in vertical walls of aircraft fuselage.

4. The Hydrofoiled Aircraft of claim 1, wherein said tunnel-units with their hydrofoils in cyclically moving water are used for generating hydrodynamic lift-forces needed to provide flights with all their requirements.

5. The Hydrofoiled Aircraft of claim 1, wherein said tunnel-units have guide-grid kits.

6. The sets of closed-loop waved tunnel-units, said in claim 1, can be used as mini-and/or big versions for heavy trucks, buses, and ships in order to apply their hydrofoils high lifting forces when need and preferably combining them with turboset-selfboosters fuel-free powerful motors.
